(19) United States
(12) Patent Application Publication
(10) Pub. No.: US 2007/0083555 A1
(43) Pub. Date: Apr. 12, 2007

(54) System for preparing personalized chronological sheets and product resulting therefrom

(75) Inventor: Joseph L. Baker, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/248,731

(22) Filed: Oct. 12, 2005

(51) Int. Cl. G06F 17/00

(52) U.S. Cl. 707/104.1

(57) ABSTRACT

The present invention is directed toward a system for rendering a personalized calendar for a series of pre-determined subscribers. The system enables users through a computer interface to select from a database of inspirational and motivational phrases and images and to obtain chronological information from a second database in order to create a highly personalized calendar sheet having a resolution of greater than about 150 lines per inch. The system may be provided at a single location or alternatively, the system may be provided at remote locations and the personalized products delivered by courier or other acceptable means.

### CROSS-REFERENCES TO RELATED APPLICATIONS

None.

### FIELD OF THE INVENTION

The present invention is in the field of systems that are utilized in the preparation of personalized, printed office products and more specifically in the field of pre-printed, custom substrates utilized for organizational efficiencies, such as individualized chronological sheets. The personalized piece includes a first portion that is dedicated to a predetermined time increment segment or portion that is intended to receive chronological information for a group of predetermined subscribers and a second portion printed with pre-selected informational indicia, such as motivational and inspirational phrases and images, pertaining to preferences obtained from a customer. In addition, the personalized calendar piece or chronological sheet may also include at least one removable or detachable element that may be used to convey additional business communications.

The system may be provided at a single location or alternatively, the system may use a global communications device to communicate between at least two locations so that subscribers can enter information at one location and then have the personalized calendar piece rendered, preferably using a high quality imaging device, at a second location. The personalized pieces are then delivered to the subscriber such as by a courier service or other suitable means. The system of the present invention can be used to generate small batches or quantities of chronological sheets or may be implemented to provide large segments of a population with such personalized information.

### BACKGROUND OF THE INVENTION

There are currently a plethora of office products, business form constructions and other stationery items that are available in the market today and yet with this inordinately large selection of offerings and permutations, there remains a continuing need to develop new products due to changes in technology, societal trends, diversification and new information handling needs of businesses and consumers alike.

The market for printed communication material is also changing and becoming more sophisticated. There is an increasing demand by users of printed communications to have a high level of quality and individualization or personalization in products that are delivered to customers and end users. In addition, there is an increasing desire to utilize all available printable space to provide communications to the recipients of such documents in order to maximize the impact of the sponsor's message that is being delivered.

Included with the large availability of office type and stationery type products, there are many calendar based offerings available in the market today. These calendars range from desktop configurations, notebook style products, wall calendars and the like all of which are intended to aid in collecting information and reminding the owner of the calendar of upcoming events and activities. One of the problems associated with such products is that such items do not adapt themselves readily to change in that the calendar cannot typically accommodate repeated modifications of occurrences. That is, the user of the calendar product will regularly write in events, record meetings and the like, typically with any available writing implement that may be available, normally the implement is a pen with permanent ink. Then, as will often happen, meetings change, events are modified and/or new things must be added and sequences of importance change. Thus, the need arises to scratch out the previous record and then make a new record of the meeting, change or event.

Making continual modifications to the pages of the calendar may lead to meetings or events being missed or simply not recorded as there is no longer any room to make the necessary changes or entry for a particular date or time as space is just not available on the page. Various products have been suggested whereby one may insert additional or supplemental pages into the calendar product to alleviate this problem; however, this requires the calendar owner to have a ready supply of these replacement or supplemental pages available.

Calendar sheets have heretofore been produced on an individual basis, such as from desktop computers and printers where one prints a schedule of meetings, events and the like that have been entered into a computer, typically by the individual or an administrative assistant. One of the drawbacks of such renderings is that the printout is relatively “drab” in its appearance and typically cannot convey inspirational or motivational messages or images to the user of such pieces. In addition, the rendering of such pieces by conventional office printing technology also potentially makes the documents unnoticeable potentially causing the document to be lost among the myriad of other papers one may have on a desk.

In addition, to the foregoing drawbacks, daily printable calendars also suffer from the inability to provide additional business communication pieces to meeting participants and others. For example in business gatherings and more typically when external participants are present, there is often a desire to hand out or distribute business cards or other business related information or marketing and advertising collateral. Such daily calendars simply do not have the ability or provide the flexibility to adapt them to this type of undertaking.

Another problem suffered by current offerings is that while calendars can be produced by individuals or in relatively small quantities, such as an administrative assistant producing daily sheets for the persons that he or she supports, there is no effective means to produce high quality chronological sheets at a relatively high resolution and with a significant improvement in quality when compared with desktop solutions. In addition, while it is possible to create large runs of products, such as through use of conventional printing presses like flexographic technology, in producing these products, there is limited opportunity to create high degrees of personalization that is sheet to sheet, in successive orders.

Typically, for a point of reference, printed screens or resolution levels that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

What is needed therefore is a system by which highly personalized chronological sheets can be produced in a relatively short time frame in various quantities and provided to a series of subscribers based on a number of preferences selected by such subscribers. The users of such systems can choose between a number of inspirational and motivational phrases and images that have been previously matched to create a portion that has been personalized based on the input of the user. Another portion of the printed sheet is used to provide chronological information that may be selectively highlighted to create a unique remembrance based system.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no convenient system by which to provide subscribers with a highly personalized chronological sheet that has first and second printable areas one of which contains a motivational and/or inspirational portion and the other a chronological portion.

In one exemplary embodiment, a system for producing individual, personalized chronological product, is provided and includes a first database that contains a first group of preferences that are selected from a group including events, phrases, images, human interest subjects and combinations thereof. The preferences are collected from a first source. A second database is provided for retaining criteria that pertains to particular chronographic information for a series of predetermined subscribers. A first computer is provided at a first location and is connected to the first and second databases and is used for recording and communicating preferences of a subscriber.

Continuing with a description of the presently described embodiment, a second computer is provided at a second location that is distinct from the first location and is used for entering information that relate to a particular individual. The second computer is used for recording the first set of preferences and the criteria selected by a user.

A transmission device is provided for transmitting information entered into the second computer to the first computer and a printing device is provided at one of the first and second locations and is used for rendering the preferences and the criteria.

A printable substrate is used and has top and bottom faces, first and second longitudinally extending sides and first and second transversely extending edges. The printable substrate has a first printed section that includes date, year and personalized events relating to the criteria of the user. A second printed portion contains printing that relates to the first group of preferences selected by the user.

A separable communication piece is removably connected to the printable substrate on one of the first and second printed substrates. The first computer instructs the printing device to image the printable substrate and to create a personalized chronological product for each subscriber.

In a still further exemplary embodiment, a personalized chronological that is produced in accordance with the following system and includes a computer that has an user interface. The computer is connected to a first database that contains motivational and inspirational phrases and images. A second database is provided and contains chronological information for a series of subscribers. A high quality image rendering device is also used in connection with the present system and generates images and textual information at a resolution of greater than about 150 lines per inch. Each of the subscribers enter choices into the computer by the user interface. At least one printable substrate is provided. The substrate has first and second faces, first and second longitudinally extending sides and first and second transversely extending edges. The computer provides instructions based on the choices to the image rendering device to create at least one personalized chronological containing motivational and inspirational imaging on the first face of the printable substrate relating to selections made by each of the subscribers.

In yet a still further embodiment, a chronological sheet is prepared using personalized and inspirational messages and includes a printable substrate that has first and second faces. A series of inspirational and motivational messages and matching images are contained within a first accessible database. A number of selectable chronological events are contained in a second database. The chronological events are specific to a group of pre-determined subscribers.

The printable substrate is printed on the first face in a first printable area with the inspirational and motivational messages and the matching images and the printable substrate is then printed on the first face in a second printable area with the chronological events that are specific to a subscriber. The printable substrate with the messages and images is printed thereon forms a personalized chronological sheet and the chronological sheet includes at least one removable business communication element.

The embodiments of the present invention also permits the selective highlighting of events and certain chronological items so that subscribers of a particular group can identify one or more printed elements of a particular importance.

The printed chronological sheets may be provided with one or more removable items which may be selected from a number of different elements. The elements include business cards, marketing and advertising collateral, reference cards, tags, coupons, pre-recorded media pieces and combinations thereof. The removable pieces may be held to the printed sheet through a number of attachment means such as removable or repositionable adhesive, frangible bonding materials and openings provided in the sheet to allow the removable item to be initially held and then readily removed from the opening.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of a chronological sheet prepared in accordance with the present invention;

FIG. 2 shows a schematic diagram of the system used in connection with preparing a chronological sheet in accordance with the present invention;

FIG. 3 illustrates a further schematic diagram showing an alternate configuration of the system used in connection with preparing a chronological sheet in accordance with the present invention; and

FIG. 4 provides a flow diagram related to using the system in connection with preparing a chronological sheet in accordance with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

Driving much of the change in the market today is the desire for a high degree of personalization and customization particularly when it pertains to convenient products that can be produced in a just in time type of configuration. In addition, the ability for a system to produce small to medium sized quantities of highly personalized products would fill an unmet need in this ever changing market.

Surprisingly, it has been found that there is no readily available subscription based service by which users can obtain highly personalized calendar products for daily, weekly and monthly planning purposes that are printed through the use of a high resolution rendering device that can produce images and textual information at greater than about 150 lines per inch. The system described in the present application is capable of generating motivational and inspirational messages along with matching graphics in connection with chronological details, some of which may be highlighted, to specifically identify criteria selected by the subscriber group.

The system of the present invention may be made available at a single location or alternatively, may be provided through use of two or more locations that are connected to one another such as through a global communication network or other suitable connection means such as a local area network or wide area network.

As used herein the term “subscribers” refers to segments or portions of a society, group, workforce, members or students of an academic institution, and other groups that may be categorized and readily defined and which may subscribe or be part of a particular collective entity.

The term “personalized information” refers to information that is printed or imaged onto a substrate or document which is generally variable or unique and which may change from sheet to sheet so as to create a customized message or communication for each recipient. Examples of personalized information may include names, addresses, descriptions, plans, coding, numbering, promotional text, recipes based on contents, etc. that may have been acquired from the intended recipient through surveys, questionnaires or answers given to various inquiries generated in response to a request for goods or services.

The term “static or fixed” information refers to printed or imaged information that generally does not change from sheet to sheet and may include a general description or body of information about particular products, services, places, etc. that may be of interest to the intended recipient and represents a standard message that the manufacturing or supplier wishes to convey to an end user or customer of the offering.

The term “batch” or “gang” refers to the grouping, collecting or assimilating individual print orders or printed products together, regardless of the type, configuration, use or application, for a single production run as may be accomplished in connection with the present invention. A batch or gang of orders for subscriber sheets may be run in a single production run in accordance with the present invention, with each sheet being preferably personalized and distinct from successive sheets in a particular production run.

As used herein the term “business communication” is used to refer to a printed or imaged piece, document or substrate that, either alone or in combination with other documents can convey a particular message, image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

Printable substrates are normally purchased in accordance with its weight per unit area. The weight or type of material is normally calculated by measuring or weighing that of a 500 sheet ream which is cut to a specified sized (“ream size”). For example, if a certain grade of paper has a specified ream size of 17×22 inches, the actual weight of 500 sheets in that size is the basis weight. A sheet with a 20 pound basis weight may be identified as 20-lb. or 20# and is customarily used in desktop printers and office use. Heavier bonds such as vellum may range from 60 to 80 pounds, Bristol board from 90 to 100 pounds and tag stock for example from 80 to 110 pounds and higher. The printable stock used in accordance with the present invention may range from a 20# bound sheet to significantly heavier board or tag stock such as an 80# or 110# stock depending on the requirements of a particular order. For example, a more economical production run may elect to use a 20# bond stock whereas heavier stocks may be used to create a more dynamic marketing based product.

The removable elements of the present invention may be held to the printable stock by repositionable and removable adhesives that may be used in accordance with the present invention are available from a wide variety of sources including Minnesota Mining and Manufacturing of St. Paul, Minn. and National Starch Company.

The removable elements may also be associated with the printable sheets such as through openings, e.g. slits, slots and the like. In addition, the removable elements may be held to the printable sheets through use of a frangible coating. An exemplary coating that may be used in the present invention is a UV curable coating distributed under the product name FT30LI and is available from Northwest Coatings Corp., Oak Creek, Wis. 53154 and is composed of various acrylate monomers and oligomers. The coating maintains a boiling point of greater than 200° C., a vapor density of greater than 1 (air=1), an evaporation rate of greater than 1 (n-Butyle Acetate=1) and a vapor pressure of less than 1 (MM HG at 25° C.).

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

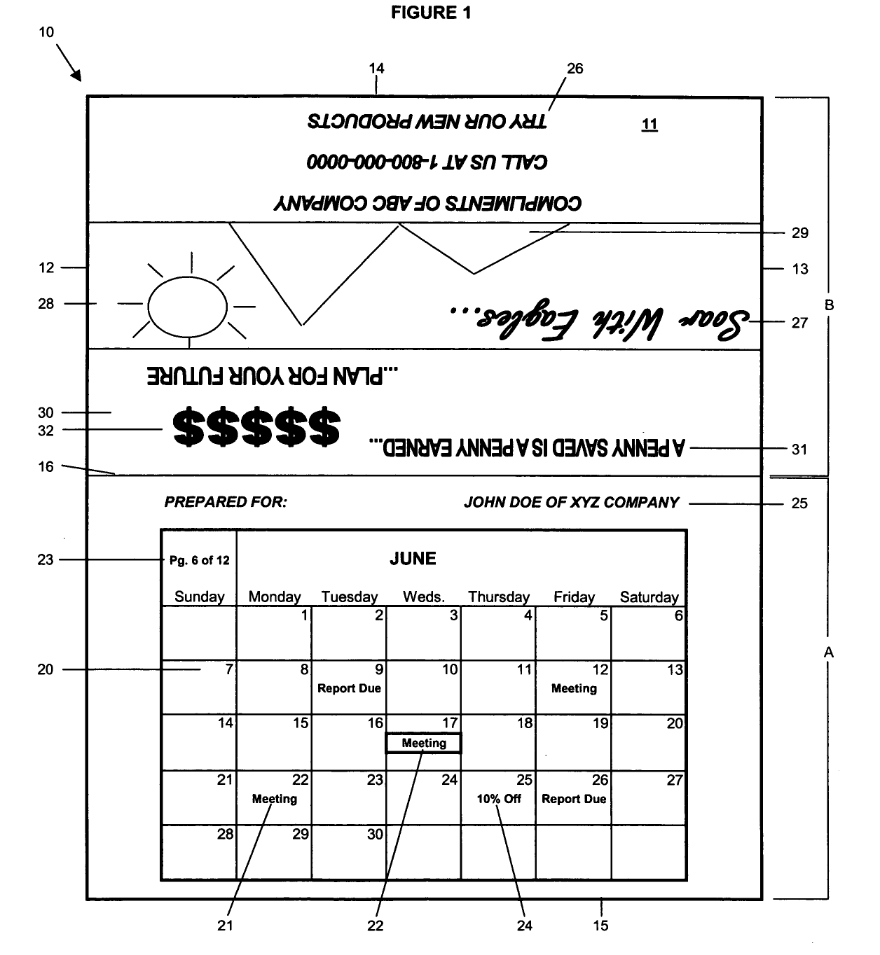

Reference is now directed to FIG. 1 of the present invention, which provides a front view of a chronological sheet 10 prepared in accordance with the present invention. The sheet 10 is preferably printed on a 20# bond stock of cellulosic material by may be printed on synthetic films, metal foils or heavier stock. The type of stock or base material used for the printable sheet will be dependent on the specifics of the particular order that has been received.

The sheet 10 has first and second sides or faces, with the first face designated by the reference numeral 11. The second face of the sheet 10 is not shown, but it is understood that the sheet of material will have two sides or faces. The sheet 10 has first and second longitudinally extending sides 12 and 13 and first and second transversely extending edges 14 and 15. The sheet will preferably have first and second portions or sections designated as “A” and “B” and illustrated by brackets shown in FIG. 1. The portions “A” and “B” are shown separated by line 16. The line may be disposed medially of the sheet or alternatively, the portion separation may be more offset to one side than the other. For example, second portion “B” may make up two thirds of the sheet 10 and the first portion “A” making up only one third of the sheet 10. Of course many options are available. The line 16 may also be used to fold the sheet so as to create a “tent” type of configuration that can be displayed on a flat surface such as a desk. In such an arrangement, it should be understood that the printing that appears on the sheet will be arranged so that the printing will appear right side up to the viewer of the sheet 10.

The first section “A” is provided with chronological information that may be laid out in a grid or other pattern. In FIG. 1 a depiction of the month of June is provide and includes a series of columns relating to the days of the week and referenced generally by numeral 20. The chronological section is printed with information relating to a subscriber's schedule and the first section “A” shows “meeting” dates referenced by numerals 21 and 22. The notation provided at 22 is highlighted to show that the meeting is particularly important whereas the notation provided at 21 is not highlighted showing another meeting but potentially of lesser significant the particular user.

The chronological portion of the printable sheet may also be printed with other static or fixed information represented by numeral 24 which shows a particular day in which a vendor that is sponsoring the program has a promotion running on the sales of goods or services. That is, each subscriber that is allowed to use the system will have this same indicia printed on their respective chronological sheets. The first printed section “A” is also provided with sequencing information 23 that shows that this particular sheet is part six of twelve in a series.

The chronological portion “A” is also printed with additional personalized information 25 which indicates the name of the particular subscriber for whom the sheet 10 has been prepared. It should be understood that while the name of the subscriber and the company is shown, other personalized information may be included such as phone numbers, significant dates (anniversaries, birthdays, etc.) may be provided and leads to increased personalization of the sheet 10.

The second portion “B” of the sheet 10 is provided with additional static information 26 which may indicate the sponsor of the subscriber offering and is shown identifying the company and includes a brief advertising message. The second portion “B” is provided with inspiration messages and graphics that are preferably pre-matched with one another to make an aesthetically pleasing composite image. One inspirational section is referenced by numeral 28 and includes a textual phrase 27 and the graphical image 29. In addition, as shown a second inspirational or motivational section is provided and referenced by 30 also include a textual portion 31 and a graphical portion 32. Again, the text and graphics portion will be matched so that when a user selects a particular message, an accompanying, relevant graphic will also be printed in the particular section.

While two inspirational sections are shown in FIG. 1, it should be understood that only one section may be created or more than two sections provided. The system in printing the sheet 10 will automatically size the area of each selection so that the selections will all fit on the sheet 10.

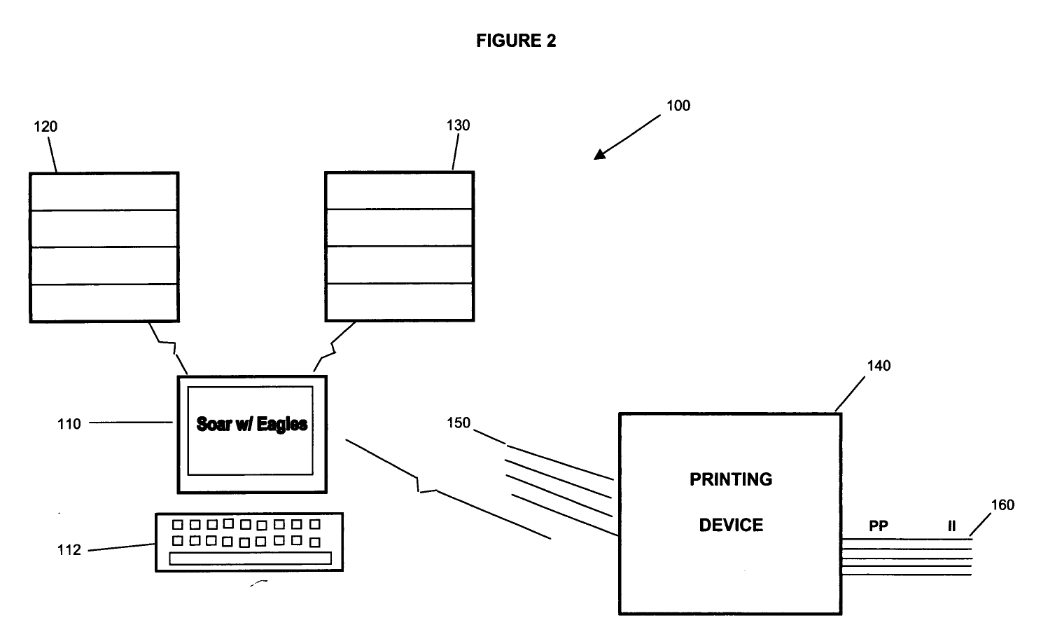

FIG. 2 presents a schematic of one embodiment of the system that is used in the preparation of the chronological sheet depicted in FIG. 1. The system in this embodiment is generally depicted by reference to numeral 100 and includes a computer 110 that has a user interface, such as a keyboard 112. The computer 110 is connected to a first database 120. The first database 120 will contain a selection of inspirational and motivational phrases that are preferably matched with images that relate to or are relevant to the phrases. The user interface 112 is used by a subscriber to make selections of inspirational and motivational phrases.

The computer 110 is also connected to a second database 130 which preferably contains chronological information relating to a particular pool of subscribers. For example, the pool of subscribers may come from a company, a business unit within a company, a group of teachers at a school, students that are part of a program and so forth. The second database 130 may be compiled by the sponsor of the chronological sheet program or may be voluntarily populated by participants in the subscription pool, such as by administrative assistants and the like.

The computer 110 is connected to a high quality printing device 140 which will print at least one and preferably a series of printable substrates 150 to create a number of chronological sheets 160 which show printing on the face through use of the designations “PP” and “II”. The computer 110 is connected to the databases 120, 130 and 140 through use of connection means such as a global communications network, local area network and wide area network.

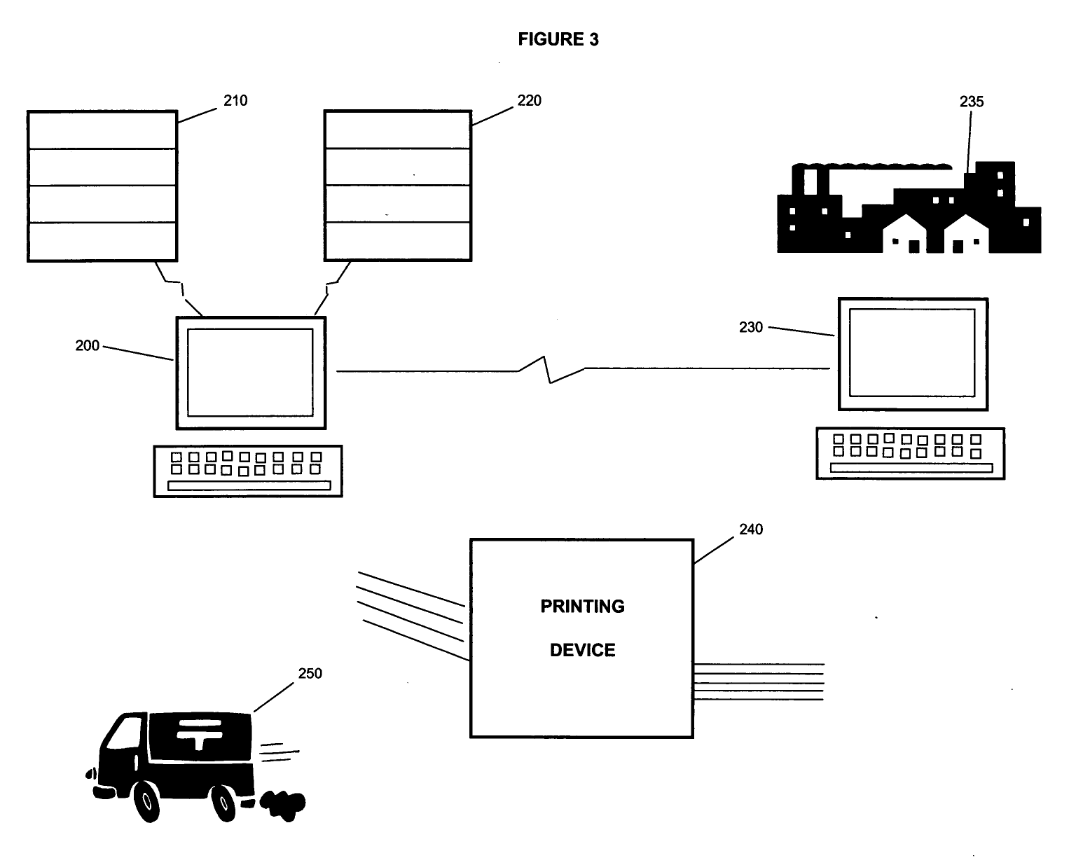

Attention is now directed to FIG. 3 of the present invention which shows a further schematic of a system used in carrying out the production of chronological sheets. The system includes a first computer 200, located at a first location that is connected to first and second databases 210 and 220. The first database 210 includes inspirational and motivational phrases that are combined with images relevant to the phrases. The second database 220 includes chronological information that is provided by a subscriber base.

The first computer 200 is connected to a second computer 230 at a second location 235 that is distinct from the first location. The second computer 230 will preferably be located at the subscriber location and will be used by subscribers to make selections stored in the first and second databases 210 and 220 and to enter personalized information such as names, dates, addresses, numbers and the like as well as to highlight select information from the chronological database. It should be understood that the distinct locations could be in different geographical areas or in the same area in different buildings or in the same building but different departments.

The first computer 200 is connected to a printing device 240 that can image the chronological sheets at a resolution of greater than about 150 lines per inch. Once the sheets are printed by the printing device 240 they are delivered such as by courier services 250 to the ordering location.

The first computer 200, second computer 230 and the printing device 240 are connected to one another though use of a global communications network, local area network and wide area network.

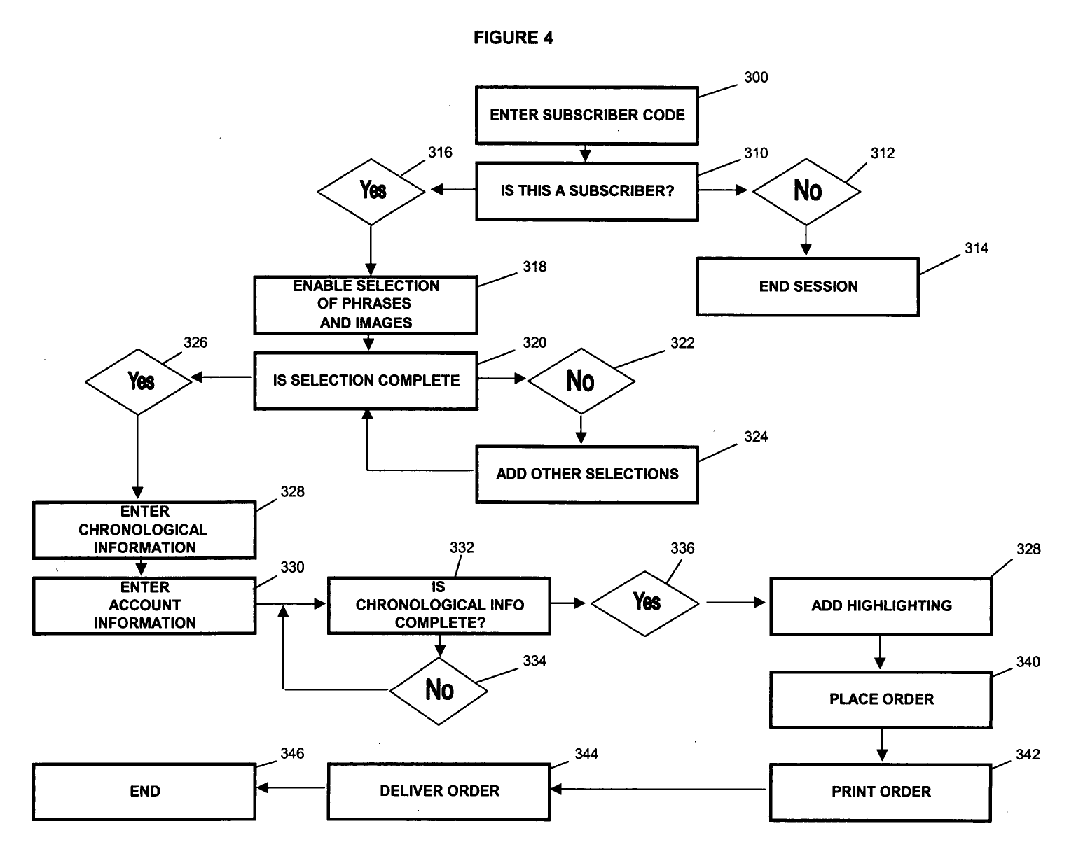

FIG. 4 is a flow diagram that is used to illustrate operation of the present invention. The subscriber will enter an access code, subscriber code or other identification on a first computer at 300. The system will then query the input at 310 to determine whether the subscriber is authorized to use the system. The system will then generate a response 312 which indicates the user on the computer is not authorized to use the system and will terminate or end the session 314. If the user is authorized at 316, the system will then enable selections of motivational and inspirational phrases and images 318. After each selection, the system will query the user 320 as to whether the selection has been completed. Alternatively, if the system detects that sufficient selections have been made for the available area on the sheet the system will move on to the next operation. If the user selects “no” 322 the system will prompt the user to enter additional selections 324 and will then again query the user after each selection or will end the selection section. If the user can select multiple phrases and images, but if the user elects not to and the selection is complete 326, the system will automatically size the selection to occupy the entire area of the second section of the printable sheet.

Once the selection of inspirational and motivational pieces has been completed at 326, the system then prompts the user to enter or select chronological information 328 and arrange for the daily, weekly, monthly, etc. accumulation of notices and other specific and personal dates. After each entry the system prompts the user as to whether the chronological information is complete 332, if not the system 334 will again permit the user to add additional date information. If the entry is complete 336 the user can add highlighting information 338 to identify critical date information for each specific subscriber enabling the subscriber to further personalize and individualize the chronological sheet.

Once the entry of the chronological information is completed the system prompts the user to enter account information 340 such as shipping information, frequency of delivery, number of copies of the sheet to be produced and the like. The system then instructs the high resolution imaging device to print the order 342 and then the order is delivered 344 and the system session ends 346.

Periodically, the system may be used to notify subscribers of the need to generate additional weekly or monthly chronological sheets for subsequent use and consumption.

As can be understood from the foregoing description, the system of the present invention allows a user to regularly create inspirational and motivational chronological sheets that can be used to emphasize a particular theme at the subscriber location or to change themes in an effort to modify attitudes or performance.

It will thus be seen according to the present invention a highly advantageous system for producing personalized chronological calendar type products has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A system for producing individual, personalized chronological product, comprising;
a first database containing a first group of preferences that are selected from a group including events, phrases, images, human interest subjects and combinations thereof and are collected from a first source;
a second database for retaining criteria pertaining to particular chronographic information for a series of predetermined subscribers;
a first computer at a first location connected to said first and second databases and said first computer is used for recording and communicating preferences of a subscriber;
a second computer at a second location, distinct from said first location, said second computer is used for entering information relating to a particular individual and for recording said first set of preferences and said criteria selected by a user;
a transmission device for transmitting information entered into said second computer to said first computer;
a printing device at one of said first and second locations for rendering said preferences and said criteria on a printable substrate;
said printable substrate having top and bottom faces, first and second longitudinally extending sides and first and second transversely extending edges, said printable substrate having a first printed section including date, year and personalized events relating said criteria of said user and a second printed portion containing printing relating to said first group of preferences selected by said user;
a separable communication piece removably connected to said printable substrate on one of said first and second printed substrates; and
wherein said first computer instructs said printing device to image said printable substrate to create a personalized chronological product for each subscriber.

2. A system as recited in claim 1, wherein said separable communication piece is selected from a group including business cards, reference cards, tags, coupons, pre-recorded media pieces and combinations thereof.

3. A system as recited in claim 1, wherein said separable communication piece is held on said printable substrate by placing said communication piece in an opening.

4. A system as recited in claim 1, wherein said separable communication piece is held on said printable substrate by a coating selected from a group including a removable adhesive, repositionable adhesive and frangible bond.

5. A system as recited in claim 1, wherein said printable substrate is selected from a material ranging from about a 20# bond to a 110# board stock.

6. A system as recited in claim 1, wherein said system provides a subscriber with reminder information concerning a need to create additional personalized chronological sheets.

7. A system as recited in claim 1, wherein said first printable section of said printable substrate may be selectively highlighted by said printing device.

8. A system as recited in claim 1, wherein said preferences are inspirational and motivational subjects and have matching related images.

9. A personalized chronological produced in accordance with the following system;
a computer having a user interface, said computer connected to a first database containing motivational and inspirational phrases and images;
a second database containing chronological information for a series of subscribers;
a high quality image rendering device for producing images and textual information at a resolution of greater than about 150 lines per inch;
each of said subscribers entering choices into said computer by said user interface;
at least one printable substrate, said substrate having first and second faces, first and second longitudinally extending sides and first and second transversely extending edges; and
wherein said computer provides instructions based on said choices to said image rendering device to create at least one personalized chronological containing motivational and inspirational imaging on said first face of said printable substrate relating to selections made by each of said subscribers.

10. A personalized chronological as recited in claim 9, wherein said printable substrate is provided with at least one removable element on one of said first and second faces.

11. A personalized chronological as recited in claim 10, wherein said removable element is removably attached to said printable substrate by a repositionable or removable adhesive.

12. A personalized chronological as recited in claim 10, wherein said removable element is removably attached to said printable substrate by a frangible bond.

13. A personalized chronological as recited in claim 10, wherein said removable element is connected to said printable substrate by an opening.

14. A personalized chronological as recited in claim 9, wherein said inspirational and motivational phrases and said images are pre-selected for rendering on said printable substrate.

15. A personalized chronological as recited in claim 9, wherein said inspirational and motivational phrases and said images are pre-matched for rendering on said printable substrate.

16. A chronological sheet prepared using personalized and inspirational messages, comprising;
a printable substrate having first and second faces;
a series of inspirational and motivational messages and matching images contained within a first accessible database;
a number of selectable chronological events contained in a second database, said chronological events are specific to a group of pre-determined subscribers;
said printable substrate is printed on said first face in a first printable area with said inspirational and motivational messages and said matching images and said printable substrate is printed on said first face in a second printable area with said chronological events that are specific to a subscriber; and
said printable substrate with said messages and images printed thereon forms a personalized chronological sheet and said chronological sheet includes at least one removable business communication element.

17. A chronological sheet as recited in claim 16, wherein said business communication element is selected from a group including business cards, promotional and advertising items, marketing collateral and combinations thereof.

18. A chronological sheet as recited in claim 16, wherein said message and said images are produced with a resolution of greater than about 150 lines per inch.

19. A chronological sheet as recited in claim 16, wherein said second printable area includes selectively highlighted portions.

20. A chronological sheet as recited in claim 16, wherein said second printable area occupies less than half of said printable substrate.
